(19) United States
(12) Patent Application Publication
(10) Pub. No.: US 2010/0182770 A1
(43) Pub. Date: Jul. 22, 2010

(54) MAKEUP PALETTE

(76) Inventor: Jung-Hui HUANG, Taiping City (TW)

Correspondence Address: Dr. BANGER SHIA;Patent Office of Bang Shia, 102 Lindencrest Ct, Sugar Land, TX, 77479-5201, US

(21) Appl. No.: 12/356,465

(22) Filed: Jan. 20, 2009

(51) Int. Cl. F21V 33/00; A45D 42/02

(52) U.S. Cl. 362/137; 132/301

(57) ABSTRACT

A makeup palette comprises a light source disposed at both sides of the cover, the light source is connected to a circuit with a reed switch, then a magnetic member is disposed at a base of the palette and located corresponding to the reed switch, and finally the cover is pivotally connected to the base, so that the reed switch and the magnetic member are controlled by the opening and closing of the cover with respect to the base to connect the light source to or to disconnect it from the power source, and thus the circuit can be closed automatically to turn on the light source, producing enough light to allow the user to fix makeup at night or when the surrounding is dim.

### BACKGROUND OF THE INVENTION

1. Field of the Invention

The present invention relates to a makeup palette, and more particularly to a makeup palette whose light can be turned on automatically when the makeup palette is opened.

2. Description of the Prior Art

Most of the modern women will dress up before going to shopping, work, or feast, and put on proper color makeup which goes with dress to look pretty and fresh. However, the color makeup is likely to come off with time and temperature change, therefore, women always take a makeup palette with them to be always ready to fix makeup at anytime.

However, the conventional makeup palette is normally a case comprising a cover and a base pivotally connected to each other. In the cover is provided a mirror, and in the base is defined a space for receiving powder or powder puff or the cosmetic-related stuff. In addition to this kind of makeup palette, manufactures also made another type of makeup palette which is provided with LEDs (light emitting diodes), however, it still has the following problems:

1. The ‘ON’ and ‘OFF’ of the power of the conventional makeup palette with LEDs is mostly controlled by pressing or touching a switch. The life of the switch is likely to be adversely affected through continuous touching and pressing, further, the switch is partially exposed out of the makeup palette, which will spoil the whole appearance of the product.

2. The light is too bright and dazzles the user since it is directly emitted out of the light source without any treatment, or light is too dim to see.

3. The circuit of the conventional makeup palette is disposed in the base where the powder or powder puff has been received, adding the wires will make the base of the makeup palette look thick, and seriously damage the appearance of the palette.

The present invention has arisen to mitigate and/or obviate the afore-described disadvantages.

### SUMMARY OF THE INVENTION

The primary objective of the present invention is to provide an easy-to-carry makeup palette whose light can be turned on automatically when the makeup palette is opened, making it easy for the user to fix makeup when the surrounding is dim.

A makeup palette in accordance with the present invention comprises: a base, a cover, a pivot connecting unit, a glass member, and a circuit. The pivot connecting unit has one side connected to the base and the other side connected to the cover. The glass member is disposed on the cover and has a mirror portion. The circuit is disposed at a predetermined position in the makeup palette and includes a reed switch, a light source and a power source which are electrically connected, the light source is located on the cover, the power source is disposed at a predetermined position on the makeup palette, the reed switch is disposed at one side of the pivot connecting unit for controlling connection and disconnection between the power source and the light source, a magnetic member is disposed at the other side of the pivot connecting unit and located corresponding to the reed switch, so that the reed switch can be controlled by the opening and closing of the cover with respect to the base to connect the light source to or to disconnect it from the power source.

### BRIEF DESCRIPTION OF THE DRAWINGS

FIG. 1 is an exploded view of a makeup palette in accordance with a preferred embodiment of the present invention;

FIG. 2 is an assembly view of the makeup palette in accordance with the preferred embodiment of the present invention;

FIG. 3 is an amplified view showing the circuit of the makeup palette in accordance with the preferred embodiment of the present invention;

FIG. 4 is a first perspective view showing the state of use of the makeup palette in accordance with the preferred embodiment of the present invention;

FIG. 4A is a first cross sectional view showing the state of use of the makeup palette in accordance with the preferred embodiment of the present invention;

FIG. 5 is a second perspective view showing the state of use of the makeup palette in accordance with the preferred embodiment of the present invention; and

FIG. 5A is a second cross sectional view showing the state of use of the makeup palette in accordance with the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

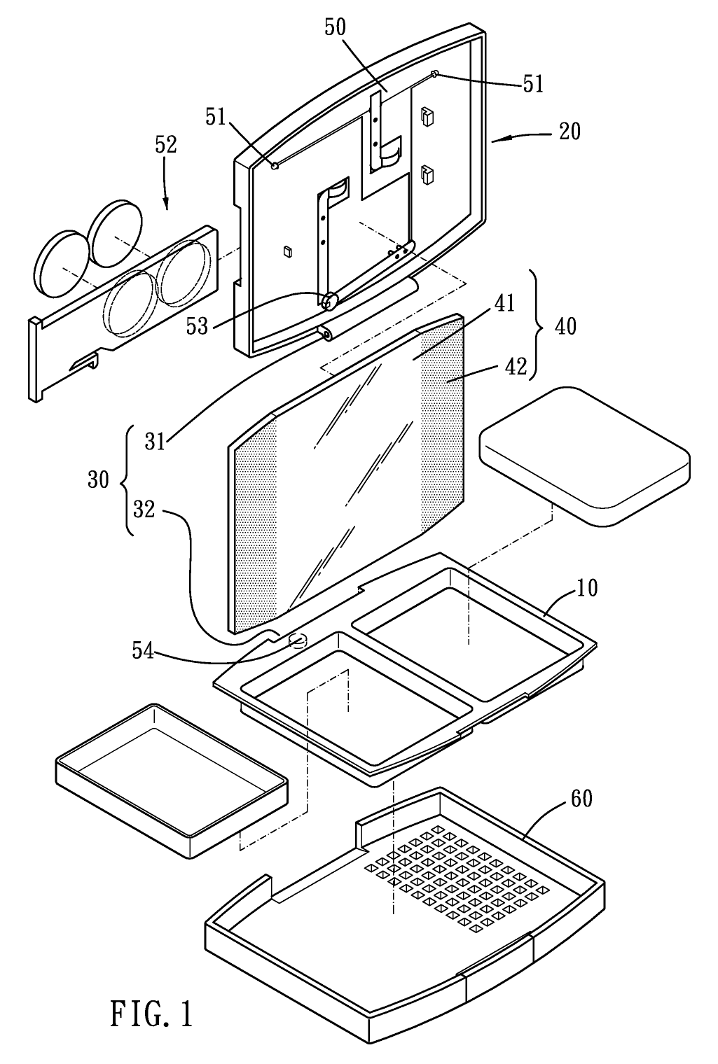

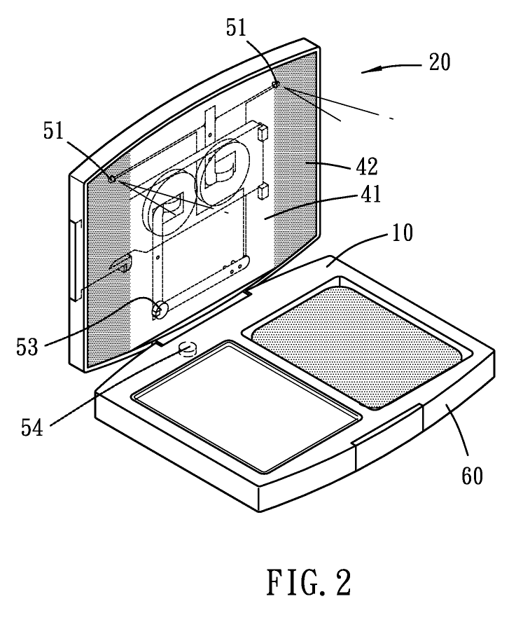

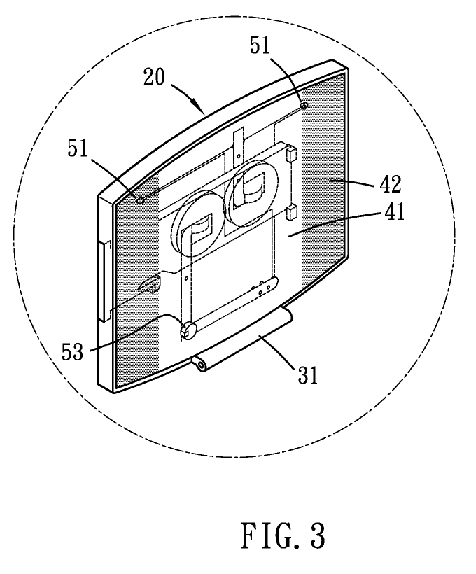

Referring to FIGS. 1-3, which are exploded, assembly and amplified views of a makeup palette in accordance with a preferred embodiment of the present invention, the makeup palette comprises: a base 10, a cover 20, a pivot connecting unit 30, a glass member 40 and a circuit 50. The cover 20 is a rectangular member with a receiving chamber in which the circuit 50 is disposed, and the glass member 40 is disposed at the entrance of the receiving chamber. The circuit 50 includes a reed switch 53, a light source 51 and a power source 52 which are electrically connected. The power source 52 in this embodiment can be a battery received in the receiving chamber of the cover 20. The reed switch 53 is disposed on a part of the cover 20, where is close to the pivot connecting unit 30. A magnetic member 54 is disposed on a part of the base 10, where corresponds to the location of the reed switch 53 and is close to the pivot connecting unit 30, so that the reed switch 53 can be controlled by the opening and closing of the cover 20 with respect to the base 10 to connect the light source 51 to or to disconnect it from the power source 52, and thus the circuit 50 can be closed automatically to turn on the light source 51 as the makeup palette is opened. The glass member 40 is disposed outside the circuit 50 to make the circuit 50 located between the cover 20 and the glass member 40. The glass member 40 includes a mirror portion 41 and two semitransparent portions 42 which are integrally formed with each other. The mirror portion 41 is located between the two semitransparent portions 42, and the light source 51 is disposed at a predetermined position between the cover 20 and the semitransparent portions 42. The mirror portion 41 is rectangular-shaped, and the light is emitted out from both sides of the glass member 40, so that, when the makeup palette opens, the light from the light source 51 is bright enough to illuminate the user s face but without dazzling her eyes.

The cover 20 and the base 10 are pivotally connected by the pivot connecting unit 30 which comprises a pivot portion 31 and a groove 32. The pivot portion 31 is formed at a predetermined position on the rear side of the cover 20, and the groove 32 is located at a predetermined position on the rear side of the base 10. The pivot connecting unit 30 has one side connected to the rear side of the cover 20 and the other side connected to the rear side of the base 10. The top surface of the base 10 is rectangular-shaped, and the base 10 is provided with a first chamber and a second chamber recessed in an interior thereof for accommodation of different cosmetic products. The makeup palette further comprises an approximately rectangular-shaped housing 60 which is provided in one of its edges with a gap for cooperating with the groove 32. The housing 60 includes a receiving chamber for receiving and mounting the base 10, and the bottom of the housing 60 is formed with grid holes located corresponding to the first chamber of the base 10.

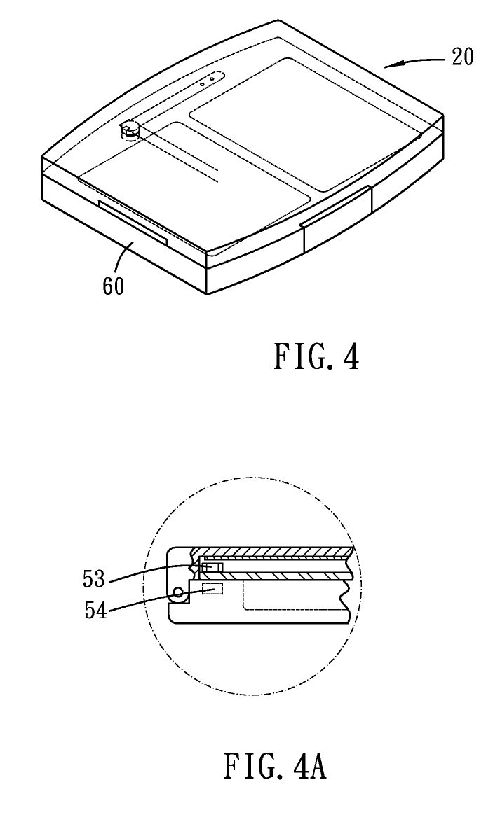

Referring then to FIGS. 4 and 4A, which are perspective and cross sectional views showing the state of use of the makeup palette of the present invention, when the makeup palette is not in use, the cover 20 is closed with respect to the base 10, as shown in FIG. 4A, the reed switch 53 is ‘Off’ since it is attracted by the magnetic member 54, so that the light source 51 is disconnected from the power source 52 and unable to produce light.

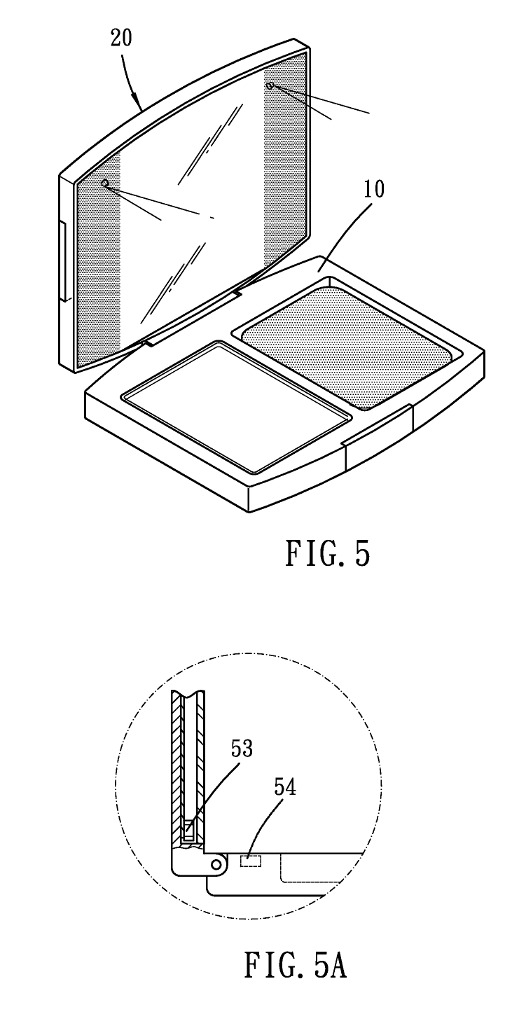

Referring then to FIGS. 5 and 5A, which are perspective and cross sectional views showing the state of use of the makeup palette of the present invention, when the makeup palette is in use, the cover 20 is opened with respect to the base 10, as shown in FIG. 5A, the reed switch 53 is switched on since it is now too far to be attracted by the magnetic member 54, so that the light source 51 is connected with the power source 52 and able to produce light.

It is apparent form the above description that the present invention has the following advantages:

1. The light source inside the makeup palette of the present invention is controlled by a reed switch which switches the circuit on and off based on magnetic attraction, hence, the switch can be hidden in the palette without spoiling its appearance, and can be used without touching or pressing, so its life is extended.

2. The glass member of the present invention is partially semitransparent so as to subdue the light, so that, the light from the light source is bright enough to illuminate the user's face but without dazzling her eyes.

3. The circuit of the makeup palette of the present invention is disposed in the chamber between the glass member and the cover, fully make use of the space of the makeup palette, making the makeup palette look more compact.

While we have shown and described various embodiments in accordance with the present invention, it is clear to those skilled in the art that further embodiments may be made without departing from the scope of the present invention.

What is claimed is:

1. A makeup palette comprising:
a base;
a cover;
a pivot connecting unit with one side connected to the base and the other side connected to the cover;
a glass member disposed on the cover and having a mirror portion; and
a circuit disposed at a predetermined position in the makeup palette and including a reed switch, a light source and a power source which are electrically connected, wherein the light source is located on the cover, the power source is disposed at a predetermined position on the makeup palette, the reed switch is disposed at one side of the pivot connecting unit for controlling connection and disconnection between the power source and the light source, a magnetic member is disposed at the other side of the pivot connecting unit and located corresponding to the reed switch, so that the reed switch and the magnetic member are controlled by opening and closing of the cover with respect to the base to connect the light source to or to disconnect it from the power source.

2. The makeup palette as claimed in claim 1, wherein the glass member further includes at least one semitransparent portion which is located at a predetermined position of the mirror portion.

3. The makeup palette as claimed in claim 2, wherein the glass member further includes two semitransparent portions which are located at both sides of the mirror portion, and the light source is disposed at a predetermined position between the cover and the semitransparent portions.

4. The makeup palette as claimed in claim 2, wherein the mirror portion and the semitransparent portions are integrally formed together.

5. The makeup palette as claimed in claim 3, wherein the mirror portion and the semitransparent portions are integrally formed together.

6. The makeup palette as claimed in claim 1, wherein the circuit and the power source are disposed on the cover.

7. The makeup palette as claimed in claim 1, wherein a top surface of the base is rectangular-shaped and at a predetermined position of one peripheral side of the base is formed a pivot connecting portion, the base is provided with a first chamber and a second chamber recessed in an interior thereof.

8. The makeup palette as claimed in claim 7 further comprising an approximately rectangular-shaped housing which is provided at a predetermined position in one of its edges with a gap for cooperating with the pivot connecting portion, the housing includes a receiving chamber for receiving and mounting the base at the predetermined position thereof, and a bottom of the housing is formed with grid holes located corresponding to the first chamber of the base.
